(19) United States
(12) Patent Application Publication
(10) Pub. No.: US 2014/0346836 A1
(43) Pub. Date: Nov. 27, 2014

(54) AUTO-INFLATABLE CUSHION TO ASSIST MOVEMENT

(71) Applicants: Joseph Leslie John Briggs, Suwanee, GA (US); Madison Rose Camp, Lawrenceville, GA (US); Grace Lauren Halley, Suwanee, GA (US); Jack Ryan Halley, Suwanee, GA (US); Kenneth Mark Halley, Suwanee, GA (US); William Henry Jameson, Suwanee, GA (US); Quintin Avery Kerns, Johns Creek, GA (US); Jackson Allen Van Grant, Dunwoody, GA (US); Breyden Krikor Wood, Atlanta, GA (US)

(72) Inventors: Joseph Leslie John Briggs, Suwanee, GA (US); Madison Rose Camp, Lawrenceville, GA (US); Grace Lauren Halley, Suwanee, GA (US); Jack Ryan Halley, Suwanee, GA (US); Kenneth Mark Halley, Suwanee, GA (US); William Henry Jameson, Suwanee, GA (US); Quintin Avery Kerns, Johns Creek, GA (US); Jackson Allen Van Grant, Dunwoody, GA (US); Breyden Krikor Wood, Atlanta, GA (US)

(21) Appl. No.: 14/247,217

(22) Filed: Apr. 7, 2014

Related U.S. Application Data
(60) Provisional application No. 61/808,972, filed on Apr. 5, 2013.

(51) Int. Cl. A61G 5/14

(52) U.S. Cl. CPC A61G 5/14; A61G 2005/1091
USPC 297/452.41

(57) ABSTRACT

An inflatable mobility assistant is an inflatable cushion that starts flat and inflates into in the shape of a wedge, giving a user, such as a senior, enough upward and forward momentum and/or movement to stand up on their own. Variations can be used for exiting a bed, sitting down, or assisting in any movements of persons or objects.

### CROSS-REFERENCE TO RELATED APPLICATIONS

This is a utility patent application being filed in the United States as a non-provisional application for patent under Title 35 U.S.C. §100 et seq. and 37 C.F.R. §1.53(b) and, claiming the benefit of the prior filing date under Title 35, U.S.C. §119(e) of the U.S. provisional application for patent that was filed on Apr. 5, 2013 and assigned Ser. No. 61/808,972, which application is incorporated herein by reference in its entirety.

### BACKGROUND

This disclosure is related to the field of devices to assist elderly, injured and/or handicapped persons and, more particularly is directed towards a device to assist individuals in rising out of a chair or other apparatus.

A small yet energetic, enthusiastic and very innovative group of young people, ranging from the 5^{th} through 7^{th} grade homeschoolers and students from Cornerstone Christian Academy, have grouped together to form a team that is responsible for the present disclosure. The group calls themselves the Determinators and they claim that there is nothing that they don't laugh about. Although they are quite innovative and industrial, they claim to never make it through a single meeting without laughing—a whole lot! In their own words, they say this about themselves:

“We always end up laughing when practicing our skit. We make sure to include everyone in all areas and everyone always has something to do. No one is left out. Sometimes we can get really crazy! Our favorite team building exercise was the “helium stick.” It was hilarious! It also taught us the importance of staying calm and working together. This year we've learned that we have to work as a team to get anything done. When things go wrong, we've learned to keep your cool, don't panic. Don't shout at or criticize your teammates if they make a mistake, encourage them instead.” Maybe this characteristic is what was described by Jesus Christ when He said “Truly I tell you, unless you change and become like little children, you will never enter the kingdom of heaven”. Matthew 18:3.

A wide array of devices have been developed to assist elderly persons, people that are recovering from surgery, people with injuries and handicapped persons. These devices include wheelchairs, automatic chair scooters, the “help, I've fallen and I can't get up” medical alert devices, in-home C-PAP machines, etc. If anyone has every had the honor of taking care of their aging parents, part of the complexity is watching them become more and more incapable of caring for themselves while they wrestle with their pride and loss of dignity in refusing to admit they need help. However, there are times when choices must be made between allowing them to endanger themselves versus trying not to rob them of their dignity.

Existing techniques that have addressed this issue seem to have two out of three of the following basic problems: (1) they are too expensive, (2) they are uncomfortable, and/or (3) they are non-portable. Existing lift chairs, such as the PRICE LIFT CHAIR, such as the CL15, manufactured by PRIDE MOBILITY, is relatively expensive and is not portable. Other available techniques and less expensive techniques, such as the RISEWELL LIFTING SEAT or UPEASY provided by UPLIFT TECHNOLOGIES are not very comfortable or portable. Further, portable lift cushions are not very comfortable and some have safety risks (i.e. spring loaded seats). Thus, there is a need in the art for a solution that addresses and overcomes these and other shortcomings

Thus, there is a need in the art for devices that can provide assistance to such persons in a manner that allows them to maintain their dignity and their self-sufficiency, just a little bit longer. The present disclosure is directed towards an innovative device that does this exactly. And this group of enthusiastic young people, in the midst of a world that is consumed by “self” have devised a product that lines up with one of the great commandments “Honor your father and your mother, that your days may be long in the land that the Lord your God is giving you” Exodus 20:12.

### BRIEF SUMMARY

The present disclosure presents various embodiments, as well as features, aspects and elements of a device that assists persons when rising from a reclined or seated position. The various embodiments will be referred to as inflatable mobility assistants. More particular, one embodiment of the inflatable mobility assistant is constructed as a seat cushion that advantageously assists elderly or other impaired individuals to rise and exit from a seated position. This embodiment addresses a very common problem among seniors. It is estimated by one facility, Noble Village located in Suwannee Ga., that over half of their residents need help rising up out of a chair. We utilize a lot of muscles when we stand up—our quadriceps, our gluteals, and our abdominals to name a few. As a general rule of thumb, people lose about 1% of muscle mass per year starting at around age 45 (some studies say as early as 25!). It appears that most of us will have to face this issue eventually. As such, the various embodiments are designed to offer a new alternative to seniors, and others who face this problem, that is portable, lightweight, affordable, provides dignity through autonomy and most of all, is comfortable! In general, this embodiment includes an inflatable device, an air compressor and an actuator. When actuated by a user, the air compressor forces air into the inflatable device. As the device inflates, it gradually raises the user from a seated position and helps to create momentum to allow the user to completely exit the chair.

Other embodiments may include a cushion to assist persons in rolling over in bed or exiting out of bed. Further, embodiments can be used to assist or soften the landing of a person into a chair, sofa or bed by operating in a reverse manner—initially being fully inflated to receive the user and then gradually deflating to allow the user to nestle into the chair.

Other chair-oriented embodiments may be constructed in such a manner to assist in sideways exiting, such as is necessary for exiting an automobile seat.

In yet another embodiment, the device may be configured to assist in lifting of objects. For instance, an inflatable mobility assistant may be placed on top of a crib mattress to assist the recovering mother or others to lift an infant from the crib.

Other embodiments may be utilized to help lift other objects, such as a counter-top device that can raise a heavy object closer to a shelf and thereby reducing the burden of lifting and storing the object. Similarly, as mattresses become thicker and heavier, embodiments of the inflatable mobility assistant could be placed under the periphery of a mattress to help lift the mattress when tucking in the sheets. In addition, many lifting injuries are caused by people lifting items from the floor and ignoring the old adage “use your legs to lift not your back”. Embodiments of the inflatable mobility assistant can be used to lift items off of the floor and greatly reduce the risk of such injuries.

These and other embodiments of the inflatable mobility assistant are move fully described with reference to the detailed description and the figures.

### BRIEF DESCRIPTION OF THE SEVERAL VIEWS OF THE DRAWING

FIG. 1 is an illustrated state diagram showing the operation of an exemplary embodiment of a wedge shaped chair IMA.

FIG. 2 is a diagram illustrating a prototype of the IMA illustrated and described in conjunction with FIG. 1 and here shown in the fully inflated steady D.

FIG. 3 is a drawing showing a front/upward angled perspective view of another exemplary embodiment of the wedge shaped chair IMA.

FIG. 4 is a side elevation view of the IMA illustrated in FIG. 3.

FIG. 5 is a more detailed diagram of an exemplary embodiment of the inflation devices illustrated in the exemplary embodiment of the IMA shown in FIG. 1.

FIG. 6A and FIG. 6B are conceptual views of additional detail that may be included in the exemplary embodiment of the IMA shown in FIG. 1.

FIG. 6C is a diagram illustrating the disassembled components that are seamed together for form the cushion 302 including the interior walls.

FIG. 7A-FIG. 7D are conceptual diagrams illustrating such an embodiment.

FIG. 8 is a functional block diagram of the components of an exemplary embodiment of controller that may be utilized in various embodiments of the IMA.

### DETAILED DESCRIPTION OF EMBODIMENTS

The present disclosure, as well as features and aspects thereof, is directed towards describing various embodiments, as well as features, aspects and elements of a device that assists persons when rising from a reclined or seated position. The various embodiments will be referred to as inflatable mobility assistants (IMA).

One embodiment of the IMA is an inflatable air cushion that starts flat and inflates into in the shape of a wedge, giving a user, such as a senior, enough upward and forward momentum and/or movement to stand up on their own. The device can be constructed of a variety of materials and in an exemplary embodiment, the cushion is constructed of PVC Vinyl fabric that is air tight, waterproof and fire-resistant as a non-limiting example. An air supply is utilized to inflate the cushion. In an exemplary embodiment the air supply can be provided by a small rechargeable air pump as a non-limiting example. In such an embodiment, the IMA is thus light and portable. The inflatable cushion includes an outer surface and an interior chamber for receiving air, gas or liquid. In an exemplary embodiment, the inflatable cushion includes a main chamber that further includes an internal support structure consisting of vinyl supports connecting the sides, top and bottom together which are configured to maintain the inflatable cushion in wedge shape instead of blowing up into a ball. Exemplary embodiments may include a safety pressure valve to prevent over inflation. Different inflation rates can be included for different functions but in an exemplary embodiment, the inflation rate can be set approximately to 15-20 seconds for complete inflation and, be designed to support up to 250 pounds. It will be appreciated that different inflation rates and load ratings are also anticipated and the provide parameters are simply a non-limiting example. After inflating, an exemplary embodiment may be configured to gradually deflate, allowing the user to go back to a seated position gently.

Additional features or aspects that may be included in various embodiments include i) a removable, washable cover with handles and designer fabrics, ii) embedding the air supply and an inflation tube into the main air chamber to prevent fall hazards due to tripping or being stepped upon, iii) using heat fused seams to construct the air chamber instead of vinyl glue, and iv) a smaller, quieter air or inflation supply.

As previously mentioned, other embodiments may be directed towards embodiments to assist users in getting in and out of a vehicle, getting in and out of bed, inclining and reclining in bed, rolling over in bed, etc.

In addition, some embodiments may implement the feature of a training mode. The training mode can be used to help build muscle strength. Such an IMA may be configured provide less and less inflation over a set period of time, requiring the user to use a little more muscle each time to stand up. Such an embodiment is advantageously suitable for individuals that are involved in physical therapy to recover from an injury.

In various embodiments, a soft, heated cover for additional comfort may be incorporated into the device or as an added accessory.

The various embodiments of the invention described herein include several advantages over the prior art, which will be apparent to one of ordinary skill in the art as well as to the user. The various embodiments are comfortable, affordable and portable.

COMFORT: Various embodiments of the IMA may include a soft material constructed from a material that folds flat when deflated. Advantageously, the user may not even be aware that the cushion is underneath the user while he or she is resting on it. Further, the user can elect to slightly inflate the IMA, so they have a thin cushion of air to sit on, helping alleviate sore spots.

AFFORDABLE: The various embodiments of the IMA are not tied to a specific chair, bed, couch or other object. As such, the user advantageously can purchase a single IMA, which has a bill of materials that is far less than the currently offered techniques, and use the IMA with any of their existing chairs or furniture, instead of having to purchase an entire piece of furniture. By employing the use of simple parts and common materials like PVC vinyl, the bill of materials for the various embodiments of the IMA is at a fraction of the cost of existing techniques.

PORTABLE: In exemplary embodiments of the IMA, the overall product may weighs less then five pounds, including a cordless, rechargeable air pump or other inflation source. The various embodiments may include handles for transporting the IMA to other seats inside and outside of the home. It is also easily folded up and stowed away for storage. Thus, a single IMA can be utilized by a user on any existing chair, newly purchased chair, church pew, airline seat, or any other seat that the user may desire to use. As such, it is readily appreciated that the various embodiments are not only comfortable, affordable and portable, but that the user's dignity is maintained by allowing a level of autonomy and avoiding embarrassment by having to have a “special chair” or being “stuck” in a chair when visiting other locations.

Further, various embodiment may employ a steady inflation tube technology that provides even and gradual delivery of the inflation mechanism, can hold its state of inflation under shifts in load or pressure, and can provide an even and gradual deflation of the cushion. To ensure the IMA inflates evenly on all sides, the steady inflation tube operates to transition the IMA to an inflated state through a single tube attached to the inflation source, such as an air pump, on one end, and runs along the seams inside of each chamber of the inflatable. The steady inflation tube is plugged on the other end, but it has different sized holes in it as is passes through each chamber. The size and number of the holes allows enhanced control over how much air goes to each chamber at the same time. In most cases, the further down the air tube you go, the bigger or more frequent the holes get, allowing further chamber to inflate at the same rate as chambers closer to the pump.

### Wedge Shaped Chair IMA

One particular embodiment of the IMA is a wedge shaped cushion for chairs. The wedged shaped chair IMA is a device that helps seniors, amputees, special-needs people, and people with special cases to get out of a chair or a bed. It is an inflatable wedge-shaped cushion with a built in air compressor and electronic self-activated auto-shut air valve that will stop all air flow when the motor receives the slightest backflow from the air in the cushion. The air compressor is rechargeable, so it does not need to be used near an electrical outlet—unless the compressor is charging. This allows the device to be portable. The compressor is stored in a pocket attached to the side of the E-Z Inflatable or secured within the internal chamber of the cushion with an air flow valve.

Turning now to the figures in which like labels refer to like elements throughout the several views, various embodiments of the IMA will be further described.

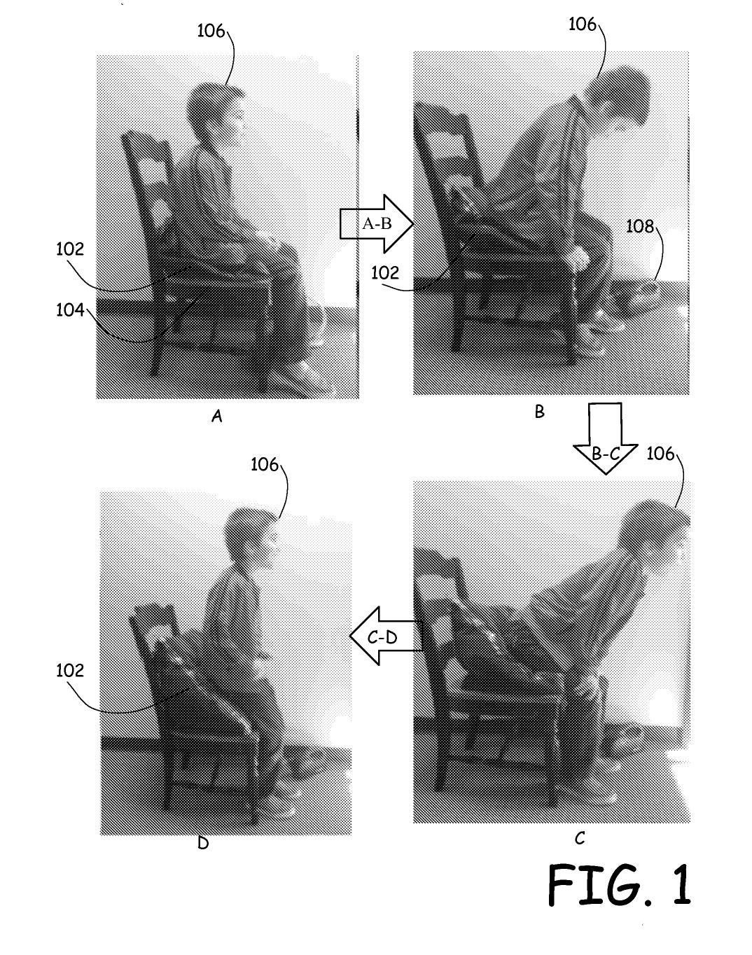

FIG. 1 is an illustrated state diagram showing the operation of an exemplary embodiment of a wedge shaped chair IMA. Initially, at the deflated steady state A, the cushion 102 of the IMA is deflated and positioned on a seating surface 104 beneath the buttocks of a user 106. When the inflation mechanism is actuated (not shown), the inflation device commences to inflate the cushion 102 shown as transition A-B where the state of the IMA is in a transitory state B of being inflated and the user 106 is shown as being slightly lifted. In the illustrated embodiment, the inflation device is shown as an external air compressor 108. As the cushion 102 is further inflated, the state diagram shows a transition to transitory state C shown as transition B-C where the user 106 is lifted to a squatting position. Ultimately, the inflation device 108 cause a full inflation of the cushion 102 and the state of the IMA transitions C-D to steady state D where the cushion 102 is fully inflated and the user is almost in an upright position and can then easily stand with little effort. In this state D, the cushion 102 is shown as being fully inflated and taking on the wedge shape. It will be appreciated that the user 106 can use the IMA to provide a “soft landing” while seating by receiving the user 106 while it is in the fully inflated steady state D. At this point, the inflating device can be turned off and deflation of the cushion 102 will commence as the state of the cushion 102 transitions back through states C and B and finally arriving at the fully deflated state A thus assisting the user 106 is seating.

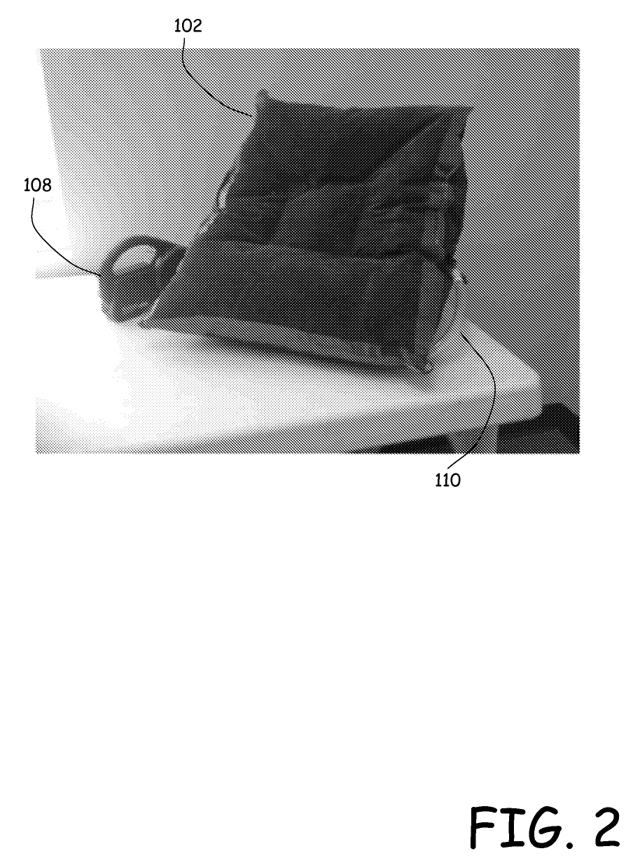

FIG. 2 is a diagram illustrating a prototype of the IMA illustrated and described in conjunction with FIG. 1 and here shown in the fully inflated state D. In the illustrated embodiment, the inflation device 108 is shown as an external air compressor and the inflation tube 110 is attached to the inflation device 108 (not illustrated) and traversing to the side of the cushion 102 where it then enters into the inner chamber of the cushion 102.

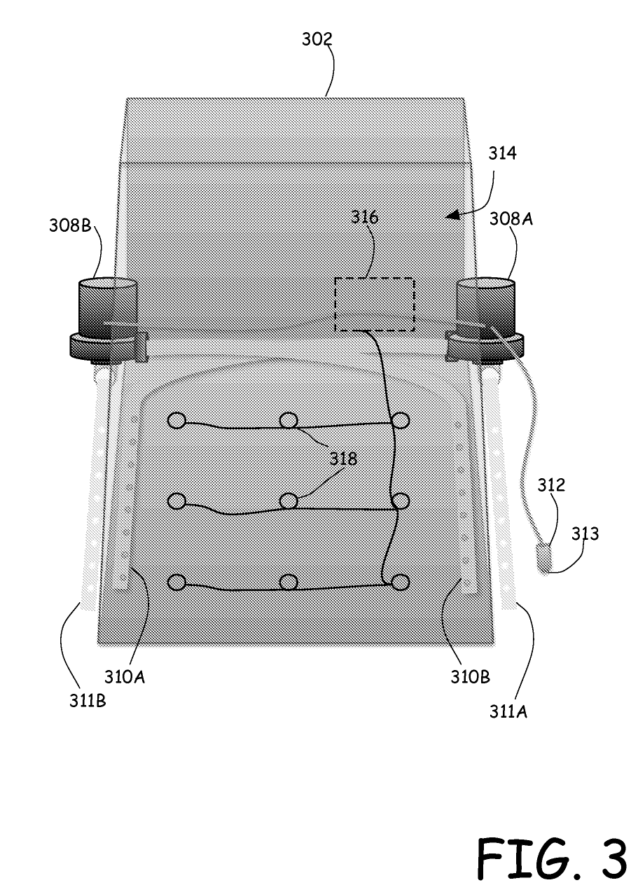

FIG. 3 is a drawing showing a front/upward angled perspective view of another exemplary embodiment of the wedge shaped chair IMA. In the illustrated embodiment, the cushion 302 is shown as including two inflation devices 308A and 308B. Each inflation device 308A and 308B includes an inflation tube 310A or 310B respectively. The inflation tubes 310A and 310B are shown as including multiple holes for regulating the volume of the air that is being forced into the cushion 102. As previously mentioned, by adjusting the number, size and location of the holes in the inflation tube, the evenness and velocity of the inflation of the cushion 102 can be controlled. Further, an actuator 312 is illustrated as being coupled to the inflation devices 308A and 308B. The actuator 312 is illustrated as including a toggle switch 313 that is coupled to and configured to actuate the electronics to control the inflation devices 308A and 308B. In addition, intake tubes 311A and 311B are illustrated as being connected to inflation devices 308A and 308B respectively. The intake tubes 311A and 311B are shown as including multiple holes that can be configured to regulate the volume and speed at which air is drawn through the inflation devices 308A and 308B. In operation, once the switch 313 is actuated while the IMA is in the fully deflated steady state A, the inflation devices 308A and 308B are turned on and they begin drawing air through the intake tubes 311A and 311B and forcing the air into the interior chamber 314 of the cushion 302.

By actuating the switch 313 a second time, the inflation devices 308A and 308B can be turned off and a regulator valve, either located within the inflation devices 308A and/or 308B can be used to regulate the speed at which the air if forced out of the interior chamber 314 of the cushion 302 when pressure is applied to the cushion 302—such as by a person beginning to sit on the cushion.

The inflation devices 308A-B may be fully embedded within the interior chamber 314 of the cushion 302 with just an interface to the air intake tubes 311A-B, partially embedded within the interior chamber 314, or fully external to the interior chamber 314 with the inflation devices interfacing to the inflation tubes 310A-B which then penetrate the wall of the cushion 302 and extend into the interior chamber 314.

It will be appreciated that in an alternate embodiment, one of the inflation devices 308A or 308B can actually work in reverse order and as such, one inflation device may be used to inflate the cushion 302 when it is turned on, while the other device may operate to deflate or draw the air out of the interior chamber 314 of the cushion 302 when it is turned on. In such an embodiment, the actuator 312 may include a more complex switch or multiple switches to provide individual control of the inflation devices.

In yet other embodiments, a controller 316 may be embedded within the device. The controller 316 may detect a first actuation of the switch 313 and cause one or more of the inflation devices 308A-B to commence inflation of the cushion and, detect a second actuation of the switch 313 to commence deflation of the cushion by either reversing one or more of the inflation devices 308A-B or turning the inflation devices 308A-B off and allowing the air to escape through a regulated valve. Further, in some embodiments, the controller 316 may interface with one or more sensors 320 that can detect the presence of force being applied to the cushion 302. Further the controller 316 may include a timer mechanism as well. In such an embodiment, an actuation of the switch 313 may cause a transition of the cushion 302 from a fully deflated steady state A to a fully inflated steady state D. In addition, a timer can be started to cause the inflation process to continue for a particular period of time. In addition to or in lieu of, the inflation process may continue until the controller 316 detects a significant decrease in pressure from sensors 318 indicating that the user has now stood up and no further inflation is required. The timer could also be used as an alert mechanism to remind the user to take medications, an alarm to wake the user if napping or dozing off, etc.

In addition, the controller 316 may detect a significant increase in pressure from sensors 318 which may indicate that a user is trying to sit down while the cushion 302 is in a fully inflated steady state D. The controller 316 may then actuate the inflation devices 308A-B to begin deflating the cushion 302. Further, the controller may utilize the timer to ensure that a certain threshold period of time has elapsed from the time that the cushion 302 was inflated and the decrease in pressure was detected prior to determining that the user is trying to sit down. This function may operate to prevent premature deflation of the cushion 302 when a user may have fallen backwards in attempting to exit the chair. In addition, monitoring the pressure sensors can also prevent premature or erroneous deflation of the cushion 302 when the user is simply slow on exiting of the chair.

In some embodiments, an audible alarm or other form of alarm may be utilized to signal that the IMA is beginning to inflate or deflate the cushion 302 to prevent surprising an unexpected user, such as if the switch 313 was accidently actuated.

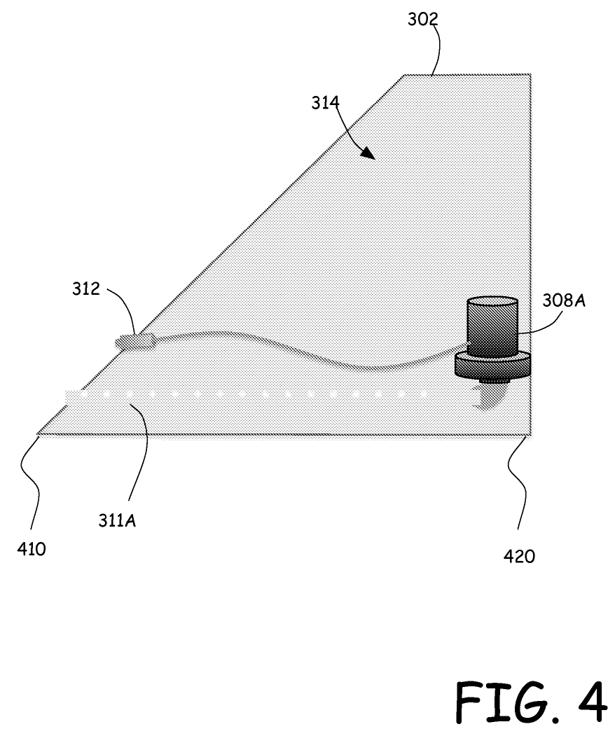

FIG. 4 is a side elevation view of the IMA illustrated in FIG. 3. In this figure, only one of the inflation devices 308A is visible, along with the actuator 312 and an external intake tube 311A. The cushion or inflatable cushion 302 is shown as being substantially wedged shape but, it will be appreciated that this is simply a general way to describe a cushion that has a front area or edge 410 that is narrow and a back area or edge 420 that is wide relative to the front area or edge 410. Thus, this can be accomplished with a variety of general shapes including parabolic shapes, egg shapes, etc.

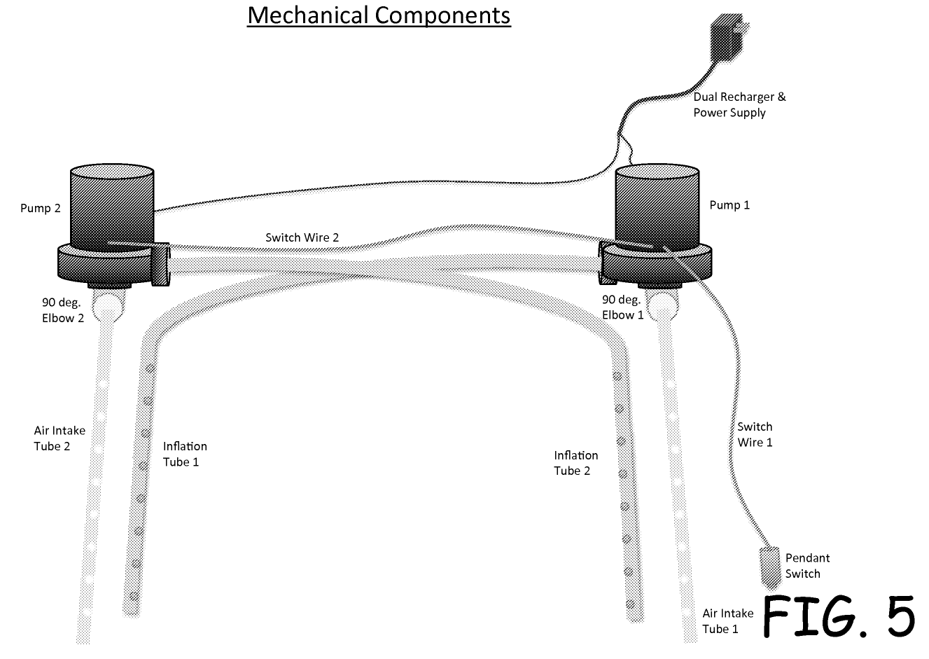

FIG. 5 is a more detailed diagram of an exemplary embodiment of the inflation devices illustrated in the exemplary embodiment of the IMA shown in FIG. 1.

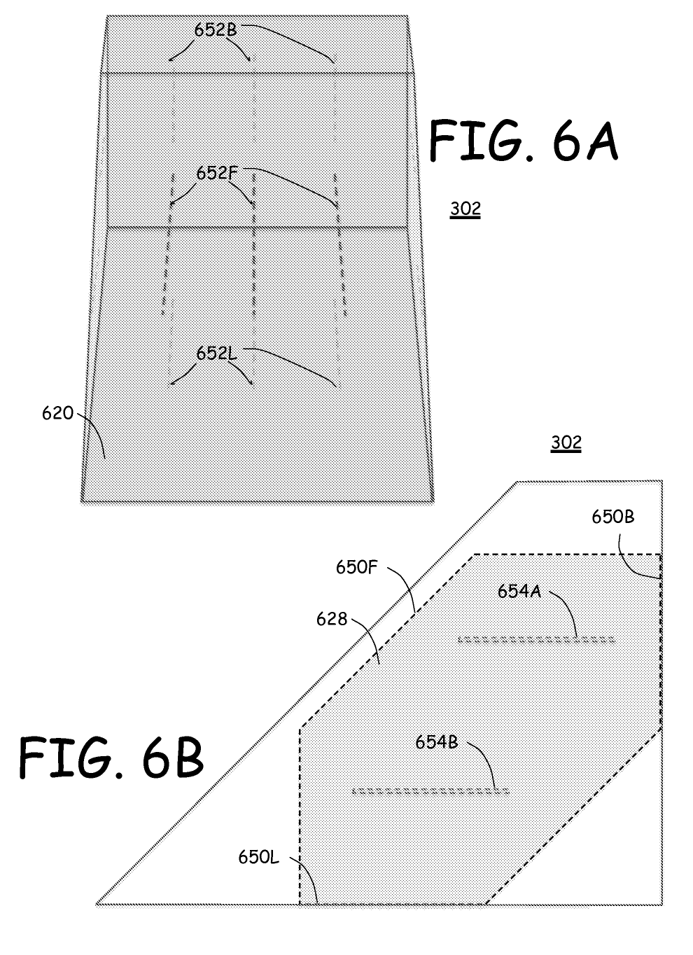

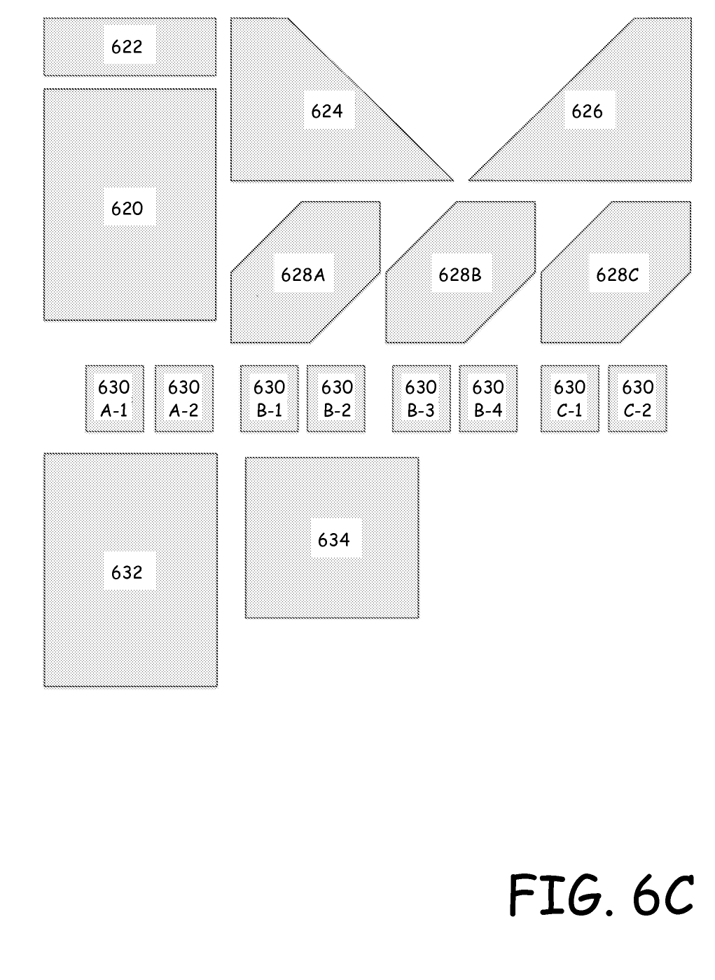

FIG. 6A and FIG. 6B are conceptual views of additional detail that may be included in the exemplary embodiment of the IMA shown in FIG. 1. In the illustrated embodiment, one or more interior walls or vertical supports 628 (FIG. 6B) are erected within the interior chamber 314 of the cushion 302.

FIG. 6C is a diagram illustrating the disassembled components that are seamed together for form the cushion 302 including the interior walls. The cushion 302 includes the following components or panels: front 620, top 622, side 1 624, side 2 626, three vertical supports 628A, 628B and 628C, eight horizontal supports 630A-1, 630A-2, 630B-1, 630B-2, 630B-3, 630B-4, 630C-1 and 630C-2, bottom 632 and back 634. The dotted lines in FIG. 6A illustrate the attachment points for vertical walls that may provide stability and airflow control baffles while inflating the cushion 302. The interior walls may be constructed of flexible material such that as the cushion 302 is inflated, the walls move into an erected state, and when the cushion 302 is deflated, the walls collapse.

Referring to FIG. 6A, FIG. 6B and FIG. 6C, vertical supports 628A, 628B and 628C are attached to the interior walls of the cushion 302. Each of the vertical supports 628 includes a back edge 650B, front edge 650F and lower edge 650L. The edges of each panel are attached to the interior walls of the cushion 302 at the set of points 652F on the top panel 620, points 652B on the back panel 634 and points 652L on the bottom panel 632 respectively. It should be appreciated that not all of these connections may be necessary in all embodiments of the IMA and the illustrated example is non-limiting. In addition, the horizontal supports 630A-1, 630A-2, 630B-1, 630B-2, 630B3, 630B-4, 630C-1 and 630C-2 may be attached between the vertical supports 628A, 628B and 628C. As a non-limiting example, two horizontal supports 630A-1 and 630A-2 can be attached between vertical support 628A and side 1 624 of the cushion 302, two horizontal supports 630C-1 and 630C-2 can be attached between vertical support 628C and side 2 626 of the cushion 302 and two horizontal supports 630B-1 and 630B-2 can be attached between vertical supports 628A and 628B and two horizontal supports 630B-3 and 630B-4 can get attached between vertical supports 628B and 628C. As a non-limiting example, the horizontal supports can be attached to the vertical supports or side panels at locations 654A and 654B.

It will be appreciated that varying number of vertical and horizontal panels, different shapes and sizes, attachment points and configurations may be utilized in the various embodiments of the IMA. The panels may be lined up as presented in FIG. 6A-FIG. 6B, the panels may be staggered, and the panels may be of various shapes and sized. Advantageously, the supports provide stability during the inflation of the cushion 302 and while it is fully inflated but, do not cause discomfort then the cushion is deflated.

In some embodiments, the vertical supports and/or horizontal supports may be fully attached to the interior walls of the cushion 302 thereby creating distinct chambers that can be independently inflated or deflated. Such configurations may be beneficial in embodiments of the IMA that may be used for exiting a vehicle, reclining or inclining in bed, adjusting a bed, assisting in the exiting of a bed, assigning in rolling over or positioning in bed, lifting items, etc.

The various embodiments have been described as including an inflatable cushion. It should be appreciated that while the cushion may typically be inflated with air or gas, the cushion may also be inflated with other substances. For instance, in some embodiments the cushion may be inflated with a liquid, such as water. Such an implementation may include an exterior reservoir for housing the liquid while the cushion is deflated and then drawing the liquid into the interior of the cushion during inflation. In alternative embodiments, the cushion may include one or more chambers that hold the liquid while the cushion is in the deflated state and then the liquid is pumped into the other chambers during inflation to assist in movement.

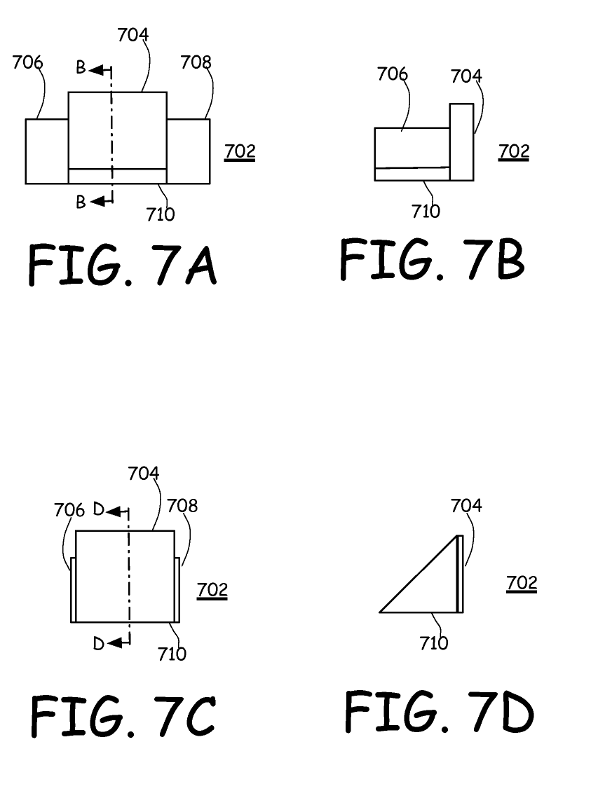

FIG. 7A-FIG. 7D are conceptual diagrams illustrating such an embodiment. For example, the cushion may be constructed such that it includes a back chamber 704 and two side chambers 706 and 708. Further, the lift or seat chamber 710 is connected to the back chamber 704 and between the two side chambers 706 and 708. When the cushion is in the deflated state, the liquid resides in the back chamber 704 to provide back support, and the side chambers 706 and 708 to provide arm rests as illustrated in FIG. 7A. The seat chamber 710 is shown as fully deflated in this state. FIG. 7B is a cross-sectional side view taken at line B-B. In FIG. 7B the cushion 710 is shown as deflated and arm rest 706 and back 704 are inflated. When the cushion is inflated, the liquid is vacated from the back chamber 704 and the two side chambers 706 and 708 and pumped into a seat chamber 710, such as a web-shaped chamber as a non-limiting example, to assist in the movement of the user. The inflated state of this embodiment is illustrated in FIG. 7C and FIG. 7D where the seat chamber 710 is fully inflated and the arm rest chambers 706 and 708 and the back chamber 704 are fully deflated.

Similar techniques can be applied to several of the embodiments described herein as well. For instance, a bed oriented IMA can be used to move the inflatable substance between various chambers to allow for body shifting and to avoid bed sores.

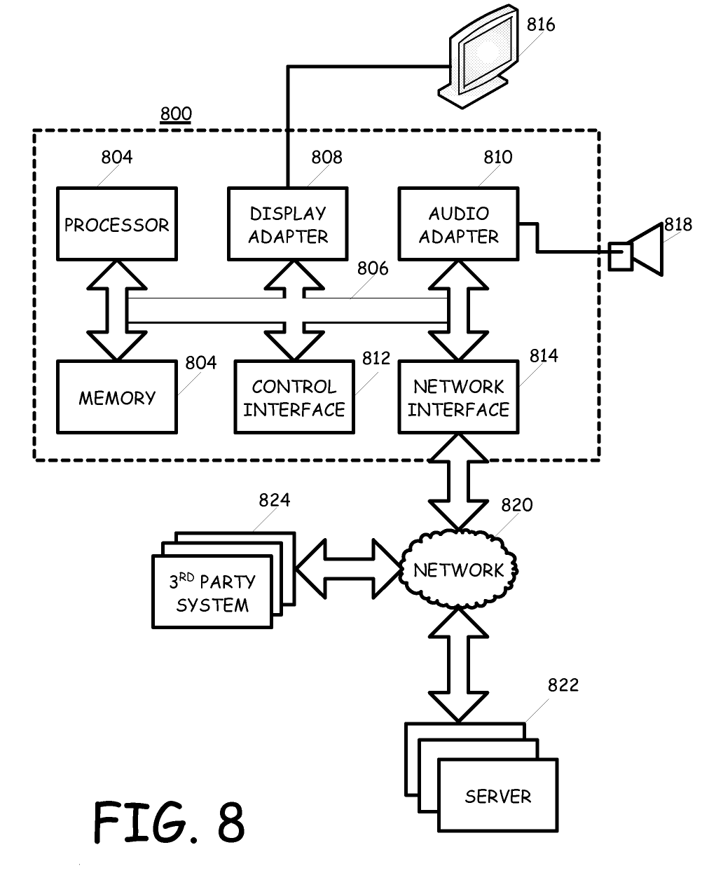

FIG. 8 is a functional block diagram of the components of an exemplary embodiment of controller that may be utilized in various embodiments of the IMA. The controller 800 may be used in various embodiments of the IMA for controlling aspects, operations and functionality of the various embodiments. It will be appreciated that not all of the components illustrated in FIG. 8 are required in all embodiments of the controller but, each of the components are presented and described in conjunction with FIG. 8 to provide a complete and overall understanding of the components. The controller can include a general computing platform 800 illustrated as including a processor/memory device 802/804 that may be integrated with each other or, communicatively connected over a bus or similar interface 806. The processor 802 can be a variety of processor types including microprocessors, micro-controllers, programmable arrays, custom IC's etc. and may also include single or multiple processors with or without accelerators or the like. The memory element of 804 may include a variety of structures, including but not limited to RAM, ROM, magnetic media, optical media, bubble memory, FLASH memory, EPROM, EEPROM, etc. The processor 802, or other components in the controller may also provide components such as a real-time clock, timer, analog to digital convertors, digital to analog convertors, etc. The processor 802 also interfaces to a variety of elements including a control interface 812, a display adapter 808, an audio adapter 810, and network/device interface 814. The control interface 812 provides an interface to external controls, such as sensors, accelerometers, pressure sensors, actuators, drawing heads, nozzles, cartridges, pressure actuators, leading mechanism, drums, step motors, a keyboard, a mouse, a pin pad, an audio activated device, as well as a variety of the many other available input and output devices or, another computer or processing device or the like. The display adapter 808 can be used to drive a variety of alert elements 816, such as display devices including an LED display, LCD display, one or more LEDs or other display devices. The audio adapter 810 interfaces to and drives another alert element 818, such as a speaker or speaker system, buzzer, bell, etc. The network/interface 814 may interface to a network 820 which may be any type of network including, but not limited to the Internet, a global network, a wide area network, a local area network, a wired network, a wireless network or any other network type including hybrids. Through the network 820, or even directly, the controller 800 can interface to other devices or computing platforms such as one or more servers 822 and/or third party systems 824. A battery or power source provides power for the controller 800. Thus, it will be appreciated that the IMA can be controlled by an actuator included with the IMA or remotely via a network and a separate computing device.

The various embodiments of the IMA include a cushion that can be constructed of a variety of materials and assembled in a variety of manners or simply be a single seamlessly constructed device. As a non-limiting example, the cushion can be constructed of a waterproof vinyl with welded seams. It also may include small supports to retain its shape, such as a wedge shape. Other materials that may be used include PVC, plastic, silicone, etc. In addition, the cushion may be constructed of a fabric and include one or more inflatable elements in the interior similar to a bicycle inner tube.

The various embodiments of the IMA may also be equipped or accompanied by one or more accessories items. Such accessory items may include, but are not limited to a waterproof slipcover that can be personalized, and has a zipper on one side so when unzipped, it can be slipped on and off with ease for cleaning, replacement, repair, etc. The slipcover may be attached to the IMA cushion by a large piece of loop and hook material, such as VELCRO, so that it can be attached and reattached at will and will not wear out easily. Another accessory may include handles that would be added so that when deflated, the IMA can be picked up and easily carried. The handles may be constructed of the same or similar material as the cushion, such as vinyl, etc. Another accessory may include a remote control unit for operating the IMA. The remote may be connected to the IMA via a tube or pocket and flaps that can be secured such as through the use of hooks and loops material (i.e., VELCRO). The flaps may latch on to chair arms so the customer can easily access the remote. When placed on a hard surface chair, the cushion may remain partly inflated even when deactivated to promote comfort to the user. These and other aspects and embodiments will be understood by one skilled in the art and the present disclosure anticipates variations to the described embodiments.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

In this application the words may be utilized to describe hardware and/or software components. It should be appreciated that anything that may be construed as existing of a process disembodied from hardware component may also be implemented in hardware components or on a processor that executes the software or code. Thus, each such component may any one of, or any combination of, software, hardware, and/or firmware.

The present invention has been described using detailed descriptions of embodiments thereof that are provided by way of example and are not intended to limit the scope of the invention. The described embodiments comprise different features, not all of which are required in all embodiments. Some embodiments utilize only some of the features or possible combinations of the features. Variations of embodiments of the present invention that are described and embodiments of the present invention comprising different combinations of features noted in the described embodiments will occur to those of ordinary skill in the art.

It will be appreciated by persons skilled in the art that the present invention is not limited by what has been particularly shown and described herein above. Rather the scope of the invention is defined by the claims that follow.

What is claimed is:

1. A device to assist in rising from a seated position, the device comprising:
an inflatable cushion, the cushion having a front edge and a back panel with an upper panel extended from the front edge to the back panel;
at least one inflation device comprising an actuator to turn the inflation device on, an air intake port and an air output port;
an air intake tube with one end of the air intake tube being coupled to the air intake port of the inflation device;
an inflation tube, with one end of the inflation tube being coupled to the air output port of the inflation device and the other end of the inflation tube being coupled to an input port of the inflatable cushion; and
the inflatable cushion being configured such that upon actuation of the inflation device causing air to be drawn into the air intake tube and delivered out the inflation tube and into the inflatable cushion, the cushion inflates to a wedge with the front edge being lower than the upper panel proximate to the back panel.

2. The device of claim 1, wherein the inflatable cushion further comprises a bottom panel, a left side panel and a right side panel, the left side panel and right side panel being adjoined along a first side with the upper panel, along a second side with the back panel and along a third side with the bottom panel.

3. The device of claim 2, wherein the upper panel, the bottom panel and the left and right side panels all meet at the front edge.

4. The device of claim 3, wherein the inflatable cushion includes one or more interior supports.

5. The device of claim 4, wherein the one or more interior supports includes one or more interior walls that are parallel to the left and right side panels.

6. The device of claim 5, wherein the one or more interior supports includes one or more horizontal supports attached between either the left and right side panel and an interior wall or, between two interior walls.

7. The device of claim 3, wherein the inflation device, the air intake tube and the inflation tube cooperate to regulate the airflow into the inflatable cushion.

8. The device of claim 3, wherein the intake tube includes one or more orifices for receiving air input, and the inflation device, the air intake tube and the inflation tube cooperate to regulate the airflow into the inflatable cushion by restricting the size and/or number of the orifices on the intake tube.

9. The device of claim 3, wherein the inflation tube includes one or more orifices for outputting air, and the inflation device, the air intake tube and the inflation tube cooperate to regulate the airflow into the inflatable cushion by restricting the size and/or number of the orifices on the inflation tube.

10. The device of claim 3, wherein the intake tube and the inflation tube include one or more orifices for receiving or outputting air respectively, and the inflation device, the air intake tube and the inflation tube cooperate to regulate the airflow into the inflatable cushion by restricting the size and/or number of the orifices on the intake tube and the inflation tube.

11. The device of claim 3, further comprising a deflation device for extracting air from the interior of the inflatable cushion.

12. The device of claim 11, wherein the deflation device and the inflation device are the same device and the actuator can be used to change the operation of the device to be an inflation device or a deflation device.

13. The device of claim 3 further comprising pressure sensors to detect if pressure is being applied against the inflatable cushion.

14. A method for assisting a subject in exiting or entering into a seated position, the method comprising the actions of:
placing an inflatable cushion onto the surface of a seat, the inflatable cushion having an deflated state and a inflated state and, when in the inflated state, the inflatable cushion being substantially wedge shaped with the front of the inflatable cushion corresponding with the lower portion of the wedge shape and the back of the inflatable cushion corresponding with the wider portion of the wedge shape, the inflatable cushion placed on the seat such that the front of the inflatable cushion is positioned proximate to the front of the seat and the back of the inflatable cushion is positioned proximate to the rear of the seat;
receiving the subject onto the inflatable cushion;
actuating an inflation device, the inflation device including an air intake and an air output, the air output being coupled to the interior of the inflatable cushion, such that air is forced into the inflatable cushion;
as the inflatable cushion inflates, moving the subject from a fully seated position towards an upright position, thereby assisting the subject in exiting the seated position.

15. The method of claim 14, wherein the action of receiving the subject further comprises the actions of:
receiving a subject while the inflatable cushion is in a fully inflated state;
actuating a deflation device, the deflation device including an air intake and an air output, the air intake being coupled to the interior of the inflatable cushion, such that air is drawn out of the inflatable cushion;
as the inflatable cushion deflates, moving the subject towards a fully seated position, thereby assigning the subject in entering a seated position.
